(19) United States
(12) Patent Application Publication
(10) Pub. No.: US 2013/0124295 A1
(43) Pub. Date: May 16, 2013

(54) SYSTEM, APPARATUS AND METHOD FOR ORGANIZING AND PRESENTING OFFERS THROUGH VIRTUAL CHANNELS

(71) Applicant: Christer BJORK, Oxie (SE)

(72) Inventor: Christer BJORK, Oxie (SE)

(73) Assignee: DANIR MARKETING AB, Malmo (SE)

(21) Appl. No.: 13/295,308

(22) Filed: Nov. 14, 2011

(51) Int. Cl. G06Q 30/02

(52) U.S. Cl. 705/14.35; 705/14.36

(57) ABSTRACT

A sales offer organizing system comprising a content provider, a user terminal, and a server. The server is configured to receive a registration for at least one channel from said content provider, receive a subscription to said at least one channel from a user of said user terminal, receive a campaign associated with said channel from said content provider, said campaign comprising organization criteria, determine if said user is to be a recipient for the content based on the organization criteria, and if said user is a subscriber to said channel, and if so, send the campaign to said user terminal

### TECHNICAL FIELD

This application relates to a method, a system and an apparatus for improved organisation of a vast number of promotions, and in particular to a method, a system and an apparatus for organising the vast number of promotions in to promotion channels.

### BACKGROUND

Today's society is a consumer driven society where very strong marketing powers are active daily promoting various goods, products and services. The number of sales offers available is vast and a single consumer is not able to siphon through the multitude of offers and it is a common fact that the amount of information presented to a user on a daily basis is far too high for a person to take it all in and the user is very likely to be bewildered or simply start to ignore what is presented. Furthermore, the vast amount of promotions and sales offers that are sent out, both electronically and in other formats arrive at a user in such quantities that the user is hardpressed to manage it all, and it becomes difficult for a user to manage and consume all information. Furthermore, many providers send out their promotions en masse thereby giving rise to the so called spam emails, which serve only to cause annoyance with buyers who could otherwise be a potential customer. The amount of sales data that is to be provided by the content providers is thus very difficult to overview. A user faced with the full data will be overwhelmed by the data and thereby unable to discern which data is of interest to the user. The purpose of the marketing system is thereby lost simply due to the size of the system.

Contemporary systems are limited in that a user is either forced to accept an offer from a provider or that the user has to come to agreements with each different provider which is both time consuming and difficult to effectuate.

There is thus a need for a system that is intuitive for a user to find the offers that he is interested in and also easy for a provider to perform targeted promotions.

### SUMMARY

It is an object of the teachings of this application to overcome the problems listed above by providing a sales offer organizing system comprising a content provider a user terminal, and a server wherein said server is configured to receive a registration for at least one channel from said content provider, receive a subscription to said at least one channel from a user of said user terminal, receive a campaign associated with said channel from said content provider, said campaign comprising organization criteria, determine whether said user is to be a recipient for the content based on the organization criteria and whether said user is a subscriber to said channel, and if so, send the campaign to said user terminal

It is also an object of the teachings of this application to overcome the problems listed above by providing a method for use in a sales offer organizing system comprising a content provider a user terminal and a server, said method comprising receiving a registration for at least one channel from said content provider, receiving a subscription to said at least one channel from a user of said user terminal, receiving a campaign associated with said channel from said content provider, said campaign comprising organization criteria, determining whether said user is to be a recipient for the content based on the organization criteria and whether said user is a subscriber to said channel, and if so, sending the campaign to said user terminal

It is also an object of the teachings of this application to overcome the problems listed above by providing a computer readable storage medium encoded with instructions that, when executed on a processor, performs the method according to above.

It is also an object of the teachings of this application to overcome the problems listed above by providing a server for use sales offer organizing system comprising a content provider and a user terminal, wherein said server comprises a controller and a memory, wherein said controller is configured to receive a registration for at least one channel from said content provider, receive a subscription to said at least one channel from a user of said user terminal, receive a campaign associated with said channel from said content provider, said campaign comprising organization criteria, determine whether said user is to be a recipient for the content based on the organization criteria and whether said user is a subscriber to said channel, and if so, send the campaign to said user terminal

It is also an object of the teachings of this application to overcome the problems listed above by providing a user terminal for use in a sales offer organizing system comprising a content provider and a server wherein said user terminal comprises a controller and a memory, wherein said controller is configured to send a subscription request for at least one channel, receive a campaign associated with said channel from said server, said campaign comprising organization criteria, present said campaign in an order based on said organization criteria, receive a selection of said campaign, and in response thereto activate a function associated with said campaign.

The inventors have realized, after inventive and insightful reasoning, that by sorting or grouping the sales offers into channels, thereby allowing a user to make a mental simile to a TV-channel, that the user can browse or subscribe to, to find the content that he is interested in. Furthermore the channel system allows a content provider to group their products and offerings into easy to overview and find channels. Additionally the campaigns are highly versatile in their usage and a provider is able to tailor a campaign to find the user s that are most interested in the campaign and who would also have the greatest immediate benefit of being made aware of the campaign. By combining a time dependency, a geographic area and a user choice of interested channels the system is able to target those users that are best served by the sales offer. It is also possible to keep a user updated with the latest changes in the sales offers for example resulting from a changed location. The teachings herein find use in marketing and promotional systems.

According to one aspect of the teachings herein, the organization of promotion data into a virtual channel is to be perceived as a queuing system where the incoming promotion campaigns arrive in virtual channels and are queued, that is distributed, to a user terminal The organization criteria specify what promotion data is to be queued to which user terminal and in what order.

The teachings herein further disclose a manner of intelligently organizing the presentation of campaigns such that a user and potential buyer is made aware of which campaign that is of most interest at any given time and place.

The teachings herein provide a simple solution to the problem of users being overwhelmed by exposure to increasing flow of advertising information that has been common in modern society for decades.

Other features and advantages of the disclosed embodiments will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF DRAWINGS

The invention will be described in further detail under reference to the accompanying drawings in which:

FIG. 1 shows a schematic view of a user terminal according to one embodiment of the teachings of this application;

FIG. 2 shows a schematic component view of the general structure of a user terminal according to one embodiment of the teachings of this application;

FIG. 3 shows a schematic component view of the general structure of a telecommunications system in which an embodiment of the teachings of this application may be used in;

FIG. 4 shows a schematic component view of the general structure of a server according to one embodiment of the teachings of this application;

FIG. 5 shows a schematic view of a system according to one embodiment of the teachings of this application;

FIG. 6 shows a schematic view of an ordering of promotional data according to one embodiment of the teachings of this application; and

FIG. 7 shows a flowchart for a method according to one embodiment of the teachings of this application;

FIG. 8 shows a flowchart for a method according to one embodiment of the teachings of this application;

FIGS. 9a-d shows a series of exemplary views of a user terminal according to one embodiment of the teachings of this application; and

FIG. 10 shows a flowchart for a method according to one embodiment of the teachings of this application.

### DETAILED DESCRIPTION

The disclosed embodiments will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

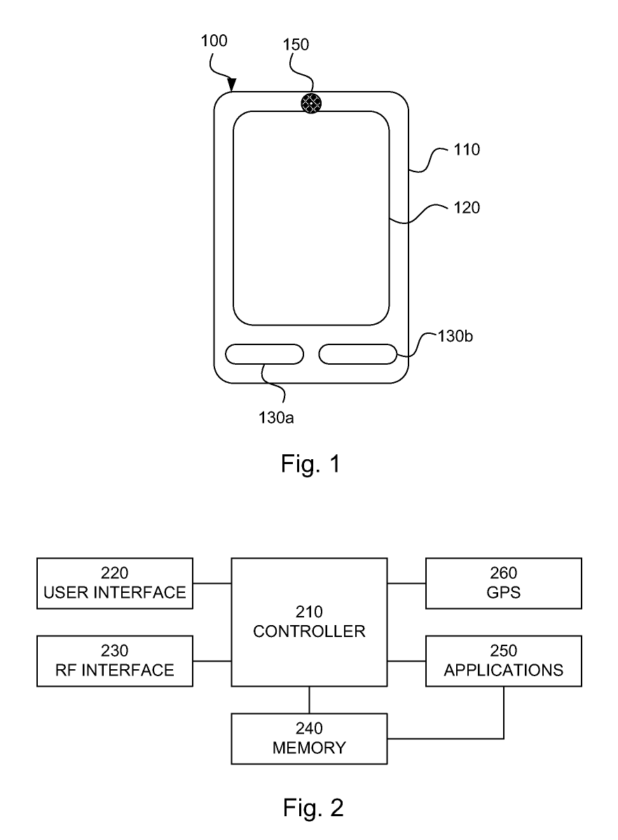

FIG. 1 shows a schematic overview of a user terminal in the form of a mobile communications device 100 adapted according to the teachings herein. In the embodiment shown the mobile communications device is a mobile phone 100. In other embodiments the mobile communications device 100 is a personal digital assistant, a media player, a location finding device or any hand-held device capable of communicating with other devices. The mobile phone 100 comprises a housing 110 in which a display 120 is arranged. In one embodiment the display 120 is a touch display. In other embodiments the display 120 is a non-touch display. Furthermore, the mobile phone 100 comprises two keys 130a, 130b. In this embodiment the there are two keys 130, but any number of keys are possible and depends on the design of the mobile phone 100. In one embodiment the mobile phone 100 is configured to display and operate a virtual key 135 on the touch display 120. It should be noted that the number of virtual keys 135 are dependant on the design of the mobile phone 100 and an application that is executed on the mobile phone 100. In one embodiment the device 100 comprises an ITU-T keypad or a QWERTY (or equivalent) keypad in addition to or as an alternative to a touch-sensitive display. In an embodiment where the keypad is an alternative to a touch-sensitive display, the display 120 is a non-touch-sensitive display.

FIG. 2 shows a schematic component view of the general structure of a user terminal according to FIG. 1. The mobile phone 100 comprises a controller 210 which is responsible for the overall operation of the mobile terminal and is preferably implemented by any commercially available CPU (“Central Processing Unit”), DSP (“Digital Signal Processor”) or any other electronic programmable logic device. The controller 210 may be implemented using instructions that enable hardware functionality, for example, by using executable computer program instructions in a general-purpose or special-purpose processor that may be stored on a computer readable storage medium (disk, memory etc) 240 to be executed by such a processor. The controller 210 is configured to read instructions from the memory 240 and execute these instructions to control the operation of the mobile device 100. The memory may be implemented using any commonly known technology for computer-readable memories such as ROM, RAM, SRAM, DRAM, CMOS, FLASH, DDR, EEPROM memory, flash memory, hard drive, optical storage or any combination thereof The mobile device 100 further comprises one or more applications 250. The applications are set of instructions that when executed by the controller 210 control the operation of the mobile device 100. The memory 240 is used for various purposes by the controller 210, one of them being for storing applications data and program instructions 250 for various software in the mobile device. The software includes a real-time operating system, drivers for a man-machine interface 220, an application handler as well as various applications 250. The applications 250 can include a messaging application for short messaging service (SMS), multimedia messaging service (MMS) and electronic mail, a media player application, as well as various other applications 250, such as applications for voice calling, video calling, web browsing, document reading and/or document editing, an instant messaging application, a phonebook application, a calendar application, a control panel application, one or more video games, a notepad application, location finding applications, etc. Alternatively, the mobile device 200 comprises a position finding apparatus such as a Global Positioning System (GPS) device 260 which may be operably executed by the position finding application.

The mobile device 200 further comprises a user interface 220, which in the mobile device 100 of figure of 1, is comprised of the display 120, the keys 130, 135 and a loudspeaker 150. The user interface (UI) 220 also includes one or more hardware controllers, which together with the UI drivers cooperate with the display 120, keypad 130, as well as various other I/O devices such as microphone 150, speaker, vibrator, ringtone generator, LED indicator, etc. As is commonly known, the user may operate the mobile terminal through the man-machine interface thus formed.

The mobile device 200 further comprises a radio frequency interface 230, which is adapted to allow the mobile device to communicate with other devices through a radio frequency band through the use of different radio frequency technologies. Examples of such technologies are W-CDMA, GSM, UTRAN, LTE and NMT to name a few. The controller 210 is configured to operably execute applications 250 such as the voice call and SMS applications through the RF interface 230 and software stored in the memory 240 which software includes various modules, protocol stacks, drivers, etc. to provide communication services (such as transport, network and connectivity) for the RF interface 230, and optionally a Bluetooth interface and/or an IrDA interface for local connectivity. The RF interface 230 comprises an internal or external antenna as well as appropriate radio circuitry for establishing and maintaining a wireless link to a base station. As is well known to a person skilled in the art, the radio circuitry comprises a series of analogue and digital electronic components, together forming a radio receiver and transmitter. These components include, i.e., band pass filters, amplifiers, mixers, local oscillators, low pass filters, AD/DA converters, etc.

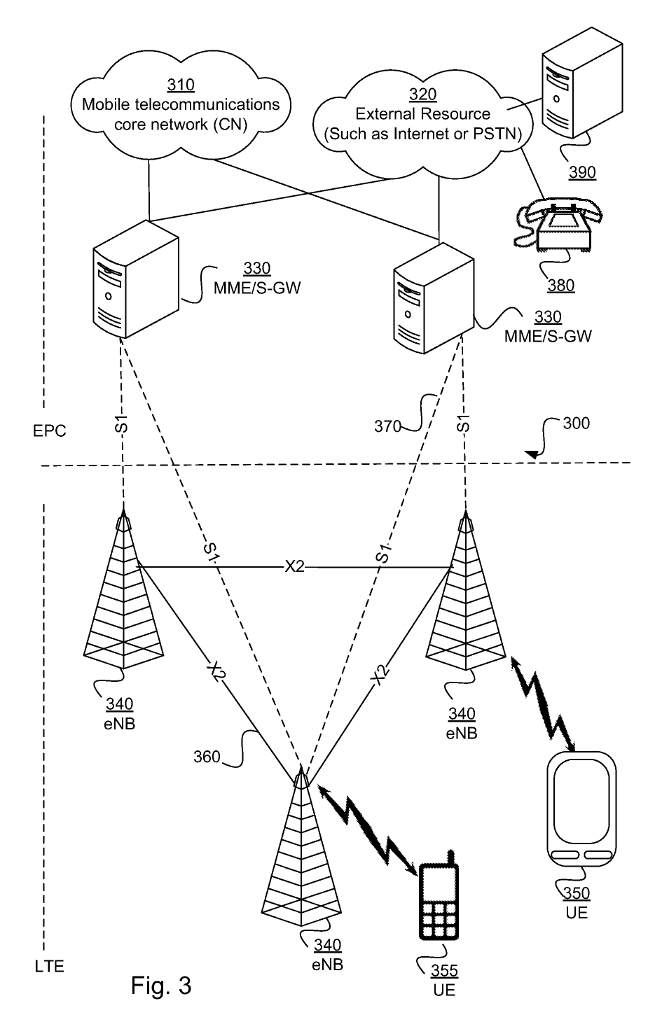

FIG. 3 shows a schematic view of the general structure of a telecommunications system 300 according to the teachings herein. In the telecommunication system of FIG. 3, various telecommunications services such as cellular voice calls, www/wap browsing, cellular video calls, data calls, facsimile transmissions, music transmissions, still image transmissions, video transmissions, electronic message transmissions and electronic commerce may be performed between a mobile terminal 100, 300 according to the disclosed embodiments and other devices, such as another mobile terminal 355 or a stationary telephone 380. The mobile terminals 350, 355 are connected to a mobile telecommunications network 310 through Radio Frequency links via base stations 340.

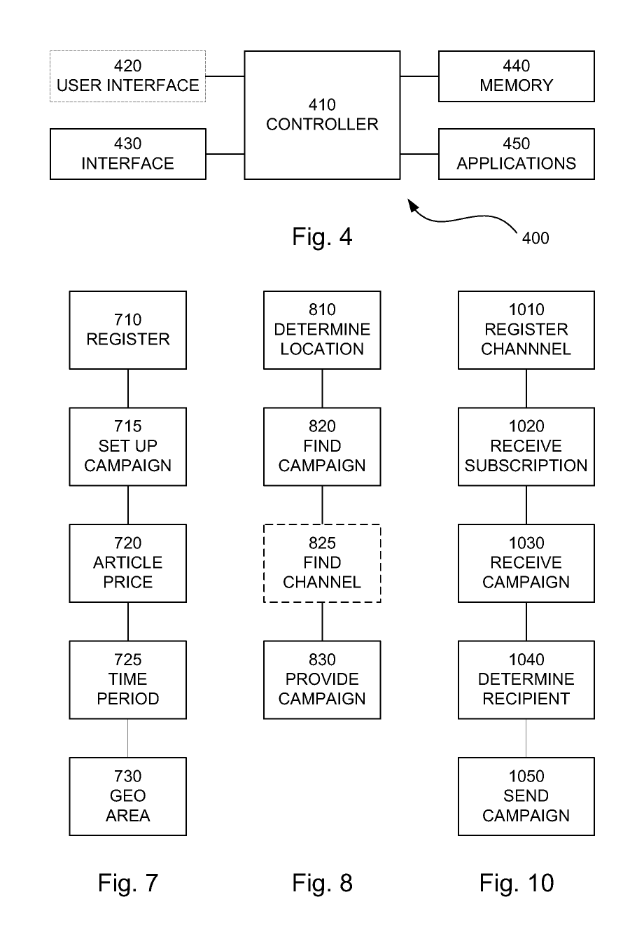

The telecommunications system 300 comprises at least one server 330. A server 330 has a data storage and a controller, preferably implemented by any commercially available CPU (“Central Processing Unit”), DSP (“Digital Signal Processor”) or any other electronic programmable logic device. FIG. 4 and the description belonging thereto gives more details on a server's main components and their functionality. In one embodiment such a server is a Mobility Management Entity (MME). In one embodiment such a server is a Gateway (GW). The servers 330 are configured to communicate with a mobile telecommunications core network (CN) 310 and/or an external resource 320 such as the internet or a Public Switched Telephone Network (PSTN). A PSTN 320 is configured to communicate with and establish communication between stationary or portable telephones 380. In one embodiment the external resource comprises or is configured to communicate with an external service provider 390. In one embodiment the servers 330 are configured to communicate with other devices using a packet switched technology or protocol. In such an embodiment the servers 330 may make up an Evolved Packet Core (EPC) layer.

The servers are configured to communicate with nodes, also referred to as base stations 340. In one embodiment the base station 340 is an evolved Node Base (eNB). A base station 340 is further configured to communicate with a server 330. In one embodiment the communication between a server 330 and a base station 340 is effected through a standard or protocol 370. In one embodiment the protocol is S1. A base station 340 is configured to communicate with another base station 340. In one embodiment the communication between a base station 340 and another base station 340 is effected through a standard or protocol 360. In one embodiment the protocol 160 is X2. A base station 140 is further configured to handle or service a cell 180. In one embodiment the at least one base stations 140 make up a Long Term Evolution (LTE) layer. In one embodiment the at least one base stations 140 make up an LTE Advanced layer.

In one embodiment the base station 140 is configured to communicate with a mobile telecommunications device 350 (100) through a wireless radio frequency protocol.

In one embodiment the telecommunications system 100 is an Evolved Packet System (EPS) network. In one embodiment the telecommunications system is a system based on the 3GPP (3^{rd} Generation Partnership Project) standard. In one embodiment the telecommunications system is a system based on the UMTS (Universal Mobile Telecommunications System) standard. In one embodiment the telecommunications system is a system based on a telecommunications standard such as GSM, D-AMPS, CDMA2000, FOMA or TD-SCDMA.

FIG. 4 illustrates an example of a server 400 such as a server 330, 390 in FIG. 3. The server 400 comprises a controller 410 which is responsible for the overall operation of the server 400 and is preferably implemented by any commercially available CPU (“Central Processing Unit”), DSP (“Digital Signal Processor”) or any other electronic programmable logic device. The controller 410 may be implemented using instructions that enable hardware functionality, for example, by using executable computer program instructions in a general-purpose or special-purpose processor that may be stored on a computer readable storage medium (disk, memory etc) 440 to be executed by such a processor. The controller 410 is configured to read instructions from the memory 440 and execute these instructions to control the operation of the server 400. The memory 440 may be implemented using any commonly known technology for computer-readable memories such as ROM, RAM, SRAM, DRAM, CMOS, FLASH, DDR, EEPROM memory, flash memory, hard drive, optical storage or any combination thereof. The server 400 further comprises one or more applications 450. The applications are set of instructions that when executed by the controller 410 control the operation of the server 400. The memory 440 is used for various purposes by the controller 410, one of them being for storing applications data and program instructions for various software in the server 400. The software includes a real-time operating system, an application handler as well as various applications 450. The applications 450 can include a messaging application for short messaging service (SMS), multimedia messaging service (MMS) and electronic mail, as well as various other applications 550, such as applications for voice calling, video calling, web browsing, document reading and/or document editing, an instant messaging application, a calendar application, a control panel application, one or more video games, etc.

Alternatively, the server 400 comprises a driver for a user interface 420. As is commonly known, a user may operate the server 400 through the user interface 420.

The server 400 further comprises an interface 430, which is adapted to allow the server 400 to communicate with other devices through for example a radio frequency band through the use of different radio frequency technologies. Examples of such technologies are W-CDMA, GSM, UTRAN, LTE, NMT to name a few. Optionally, the server 400 comprises a Bluetooth interface and/or an IrDA interface for local connectivity.

FIG. 5 illustrates a system 500 according to the teachings herein. In FIG. 5 the server 520 is illustrated as being one single server 520, however, it should be understood that the server 520 may be implemented through a collection of servers or other computational devices. A server 520 is in one embodiment a server as is illustrated in FIG. 4. The server 520 is configured to receive content from at least one content provider 510a-510d. In FIG. 5 the content providers 510 are illustrated as being servers, however, it should be understood that the content providers 510 may be implemented through any device capable of storing content and to communicate said content to said server 520. The server 520 is arranged to receive one or multiple contents from each content provider 510 as indicated by the multiple arrows from the content providers 510 to the server 520. In one embodiment a content provider represents a manufacturer of a product or an article or a provider of a product or an article. It should be noted that in this application a product is to be understood as also including a service. Hereafter an article will be assumed to mean a product or an article or a service. In one embodiment a content provider represents a store. In one embodiment a content provider represents a franchise. In one embodiment a content provider represents a chain of stores. In one embodiment a content provider represents a collection of content providers.

The content provided to the server 520 comprises information on a sales campaign. Such sales information includes at least one of an article and a price. The sales information further includes a recipient or target group. The sales information further includes information on a time period. In one embodiment the time period is given as a start time and duration. In one embodiment the time period is given as a start time and an end time. It should be noted that as it relates to the time difference the term “time” is considered to include a date and a time. The sales information further includes information on a geographic area, hereafter referred to as geographic data. In one embodiment the geographic data includes data on a centre point and a radius. In one embodiment the geographic data includes data limiting an area, limiting a street address, limiting a post code, limiting a neighbourhood, limiting a town, limiting a city, limiting a county, limiting a state and/or limiting a country. Such limiting data is in one embodiment geographical coordinates.

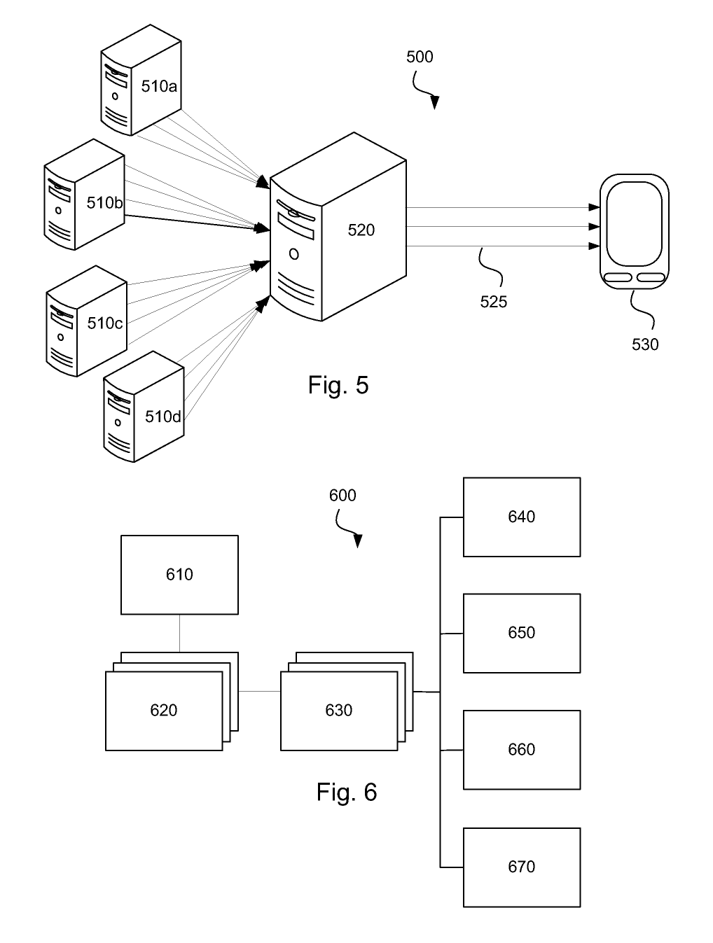

To allow a user to be able to discern between all the offers provided by the content providers 510 a system and a method has been realised by the providers of the teachings herein. The system and method is based on an inventive manner of ordering the sales data for storing, forwarding, distributing and presentation of the sales data. FIG. 6 illustrates a schematic view of such an ordering of sales data 600.

The sales data 600 is organized according to which content provider 610 that provides the articles, products or services. The content is further arranged in various channels 620. In one embodiment a channel 620 represents a content provider 610. In one embodiment a channel 620 represents a sub-area or sub-department of a content provider 610. In one example a channel represents a major clothes provider such as the well-known Hennes & Mauritz®. In one example a channel represents the men's collection department of a major clothes provider such as the well-known Hennes & Mauritz®. In one example a channel represents the shirt collection of a men's collection department of a major clothes provider such as the well-known Hennes & Mauritz®. It should be noted that a content provider may have any number of channels associated with it. A channel 620 is associated with one or several campaigns 630. In one embodiment a campaign 630 is associated with an article or a range of articles and the price for the article 640. The campaign 630 is further associated with a time period 650 during which time period 650 the campaign is valid. The campaign 630 is also associated with a geographic area 660 in which area the campaign 660 is valid. In one embodiment the campaign 630 is further associated with a target group 670 of potential buyers. In one embodiment the target group 670 is based on criteria relating to at least one of sex, age, education, geographic area, social status etc. In one embodiment the target group 670 is based on criteria relating to a potential buyer's subscribed channels 610. One example of a campaign 630 is an offering to buy cheap short-sleeved shirts at a reduced price starting on May 1, 2011 and ending on May 10, 2011 and which campaign is directed at male users that are in the age range of 25-45 years and live in London, England.

Returning to FIG. 5 the server 520 is configured to receive the content provided from the content providers 510 in campaign format and to organize the content received according to organizing criteria of the campaign 630. In one embodiment the sales information is used as organizing criteria. The server 520 is further configured to distribute the received content according to the organisation of the content through virtual channels 525 so that the content is received by a user who has indicated that he is interested in such campaigns 630. The campaigns 630 are thus received only by those users that are actually interested in the campaigns and not distributed en-masse to just any user and thereby possibly bewildering that user or even annoying that user causing ill-will to be associated with the good name of the content provider's brand name.

FIG. 7 shows a flowchart of a method according to herein. The method is to be performed under primary supervision or control by the server 520 possibly through a client of the server 520. Initially 710 a content provider 510 registers with the server 520 and is thereby 715 enabled to set up a channel 620. It should be noted that, as has been disclosed above, a content provider 510 may set up more than one channel 620. The content provider 510 is prompted 720 by the server 520 to indicate a name and an article 640 to be associated with the campaign 630 and possibly a price. In one embodiment the price is given indirectly through a discount. In one embodiment the discount is given as a percentage to be subtracted from a price. The content provider 510 is also prompted 725 by the server 520 to indicate a time period 650 to be associated with the campaign 630. In one embodiment the time period is given as a start time and duration. In one embodiment the time period is given as a start time and an end time. The content provider 510 is further prompted 730 by the server 520 to indicate a geographic area 660 to be associated with the campaign 630. In one embodiment the geographic area is given as a centre point and a distance (such as a radius). In one embodiment the geographic area is given as a street address, a post code, a neighbourhood, a town, a city, a county, a state or a country or a collection of countries. This allows for a campaign to be associated with a (very) specific area. In one embodiment the server 520 further prompts the content provider 510 for a target group 670. In one embodiment the target group 670 relates to at least one subscriber of the channel 620. In one embodiment the target group 670 relates to criteria relating to at least one of sex, age, education, geographic area, social status etc.

In one embodiment the server 520 is configured to implement a campaign 630 as a text campaign 630, a multimedia campaign 630 or a discount campaign 630. For a text campaign 630 the server 520 is configured to prompt the content provider 510 to provide a text body to include in the campaign 630. For a multimedia campaign 630 the server 520 is configured to prompt the content provider 510 to provide a text body, an image or a video clip to include in the campaign 630. For a discount campaign 630 the server 520 is configured to prompt the content provider 510 to provide a discount code to include in the campaign 630. In one embodiment the server is configured to implement a campaign 630 as a personal campaign 630. For a personal campaign 630 the server 520 is configured to prompt the content provider 510 to provide a recipient to include in the campaign 630. This allows a content provider to provide a highly detailed offer to a specific target group in a specific geographic area. This is beneficial as it reduces the need for en-masse advertising. In one embodiment the server 520 is configured to associate the campaign with a QR-code (Quick Response) and in such an embodiment the server is configured to prompt the content provider 510 to provide a QR-code to include in the campaign 630. As is known to a skilled person a QR-code may be associated with a web page link that is to be fetched as the QR-code is interpreted. In one such embodiment the user terminal 530 is configured to capture an image of the QR-code and to interpret the code. The code is, in one embodiment, associated with a subscription to a channel 620 and the user terminal 530 is configured to send a subscription request to the server 520 for the specified channel 620. The code is, in one embodiment, associated with a campaign and the user terminal 530 is configured to send a request to the server 520 for the specified campaign 630. In one embodiment the user terminal 530 is configured to send a subscription request for a channel 620 associated with the specified campaign in addition to the request for the campaign 630 to the server 520. In one embodiment the QR-code is additionally or alternatively associated with an electronic coupon. More details on electric coupons will be given below.

In one embodiment the server 520 is configured to associate the campaign with a hyperlink and in such an embodiment the server is configured to prompt the content provider 510 to provide a hyperlink to include in the campaign 630. As is known to a skilled person a hyperlink may be associated with a web page link that is to be fetched as the hyperlink is selected y a user. This allows a content provider to provide information to a user in a format and an amount chosen by the content provider.

In one embodiment the server 520 is further configured to allow a user of a mobile terminal 100 to display a listing of available channels to a user. In one such embodiment the server 520 is configured to provide the user terminal with a sorted listing of the available channels 620 based on the content provider 610. This allows a user to easily find channels from a specific provider that the user is aware of In one such embodiment the server 520 is configured to alternatively or additionally sort the available channels 620 based on a specific area of interest. This allows a user to easily find channels from a provider that provides articles in an interest area that the user is interested in. In one such embodiment the server 520 is configured to alternatively or additionally sort the available channels 620 based on a specific geographic area. This allows a user to easily find channels from a provider that provides articles in a geographic area that the user is interested in or currently within.

In one embodiment the user terminal 530 is configured to capture and interpret a QR code and send a subscription request to a server 520 to subscribe to a channel 620 associated with the QR-code. A content provider is thus able to advertise a campaign and allow a user to subscribe to an associated channel by including a QR-code in the advertising material.

In one embodiment the server 520 is further configured to enable a content provider to invite a user, possibly through a campaign or through a dedicated message, to subscribe to a specific channel or a group of channels. In one embodiment the server 520 is configured to allow other users than the content provider to extend such an invitation. A user terminal 530 is configured to receive such an invitation and to present it to a user. The user terminal 530 is further configured to determine whether the user accepts the invitation or not, and if so, send a subscription request for the specified channel(s) to the server 520. In one embodiment the user terminal 530 is further configured to forward such an invitation to another user. In one embodiment the user terminal 530 is also configured to create and send an invitation for a channel to another user. This allows for channels to be distributed between friends. In one embodiment a channel is arranged to not be searchable but only possible to subscribe to after an invitation has been received to that channel. This allows content providers to create an air of luxury or mystery around a channel.

In one embodiment the server 520 is further configured to enable a user terminal 530 to search among available channels 620. In one embodiment the server 530 is configured to enable such a search based on criteria such as brand, area of use, geographic area, associated channels, discount levels etc. This allows for a user to search for and subscribe to channels that are of interest to a user.

In one embodiment the server 520 is further configured to enable a user terminal 530 to browse among available channels 620. In one embodiment the server 530 is configured to enable such browsing based on brand names, area of use, geographic area, associated channels, discount levels etc. This allows for a user to browse through and subscribe to channels that are of interest to a user, but that the user was not previously aware existed.

By associating the campaigns with a geographic area it is possible to direct campaigns to user in or close to that geographic area and to avoid bewildering other users. FIG. 8 shows a flow chart of an example method of providing campaigns based on a geographic location according to herein. A user terminal 530 is configured to determine its present location and to report the location 810 to a server 520. In one such embodiment the server 520 is configured to make use of location finding techniques such as using a GPS device 270 or a cell-id determining scheme to determine the location of the terminal In one embodiment the controller 520 is configured to determine the position of the user terminal 530. In one such embodiment the server 520 is configured to make use of location finding techniques such as cell-id to determine the location of the terminal In one embodiment the user terminal 530 and/or the server 520 is configured to determine a projected location of the user terminal 530. The projected location is determined based on a current position, a known or calculated speed and a known or calculated direction. The direction may be taken from a digital map.

The server 520 is configured to receive 820, from a user terminal 530 or from the server itself 520 or a client to the server 520, a location for the user terminal 530 and in response thereto determine if a campaign 630 is associated with a geographic area 660 covering said location. In one embodiment server 520 is further alternatively configured to determine if a campaign 630 is associated with a current time period. In one embodiment the server is further additionally or alternatively configured to determine 825 if a channel 620 is associated with a geographic area 660 covering said location. The server 520 is furthermore configured to provide 830 any found campaign 630 and/or an invitation to a found channel to the user terminal 530. This allows a user to be informed of currently active campaigns in an area that the user enters or is about to enter. It is also possible to provide information on future sales campaigns to a user entering a new location wherein the campaigns are associated with the location. It is also possible to inform a user on how a campaign has differed from the previous are that the user is leaving to the new location that the user is entering. An example is that a user that is leaving a country outside an economic zone, such as the European Union, enters a country in the economic zone is made aware of any prize changes resulting from raised/lower import taxes due to the economic zone.

In one such embodiment a user terminal is configured to receive a location from a user and to forward the location to the server to be used as an assumed location of the user terminal. This allows a user to investigate what campaigns are available at other locations, which can be highly useful when planning a trip such as a holiday.

In one embodiment the geographic data also enables a server to maintain a virtual plaza by associating the virtual plaza with a geographic location. A user terminal 530 entering a specific geographic area that is associated with a virtual plaza can thus prompt a server 520 to see what campaigns that are valid in the virtual plaza, that is have a geographic data that corresponds to the location of the virtual plaza. Alternatively the server 520 is configured to determine that a user terminal 530 has entered a geographic area that is associated with a virtual plaza and provide the user terminal 530 with at least one campaign that is valid in the virtual plaza. This allows for a user to be made aware of campaigns from providers that he has indicated an interest in as he enters a new area.

A user terminal 530 is configured to receive a campaign 630 from a server 520 through a virtual channel 620. In one embodiment the server 520 is configured to provide a campaign 630 to a user terminal 530 through an SMS. In one embodiment the server 520 is configured to provide a campaign 630 to a user terminal 530 through an MMS. In one embodiment the server 520 is configured to provide a campaign 630 to a user terminal 530 through an email. In one embodiment the server 520 is configured to provide a campaign 630 to a user terminal 530 through a specialized communication message.

In one embodiment the user terminal 530 is configured to arrange the received campaigns 630 according to the time/date for receiving the campaign 630. This allows a user to see which campaigns have been received most recently. In one embodiment the user terminal 530 is further or alternatively configured to arrange the received campaigns 630 according to the time period for which the campaign 630 is valid. This allows a user to see which campaigns are currently active or about to be active. In one embodiment the user terminal 530 is configured to delete a campaign 630 that has a time period that has passed.

In one embodiment the user terminal 530 is further or alternatively configured to arrange the received campaigns 630 according to a number of other users that has subscribed received the campaign 630. In such an embodiment the server 520 is configured to provide the terminal 530 with updated information on how many users that has received the campaign 630. This allows a user to see which campaigns are popular. In one embodiment the user terminal 530 is further or alternatively configured to arrange the received campaigns 630 according to how many users that have made use of the campaign 630, such as performing a purchase through the campaign 630. In such an embodiment the server 520 is configured to provide the terminal 530 with updated information on how many users that has taken use of the campaign 630. In one embodiment the user terminal 530 is further or alternatively configured to arrange the received campaigns 630 according to how many users that have indicated a liking of the campaign 630. In such an embodiment the server 520 is configured to receive an indication that a user likes a campaign from a user terminal 530 (possibly another user terminal) and to provide the user terminal 530 with updated information on how many users that has indicted a liking of the campaign 630. This allows a user to see which campaigns are popular. In one embodiment the user terminal 530 is further or alternatively configured to arrange the received campaigns 630 according to how many users that are subscribing to the channel 620 that the campaign 630 is associated with. This allows a user to easily see campaigns 630 from popular channels 620 and content providers 610.

In one embodiment the user terminal 530 is further or alternatively configured to arrange the received campaigns 630 according to a distance to the geographic area 660 that is associated with the campaign 630. This allows a user to see which campaigns are most relevant with reference to the current location. It also ensures that as a user is nearing or entering a provider such as a shop the user is made aware of any campaigns currently active in the shop. This also enables content providers to set up geographic areas specific to a competitor's outlets thereby ensuring that a user is made aware of current campaigns as the user nears or enters a competitor's shop or store. In one embodiment the user terminal 530 is configured to sort the campaigns primarily on the distance to the geographic area associated with the campaign 630.

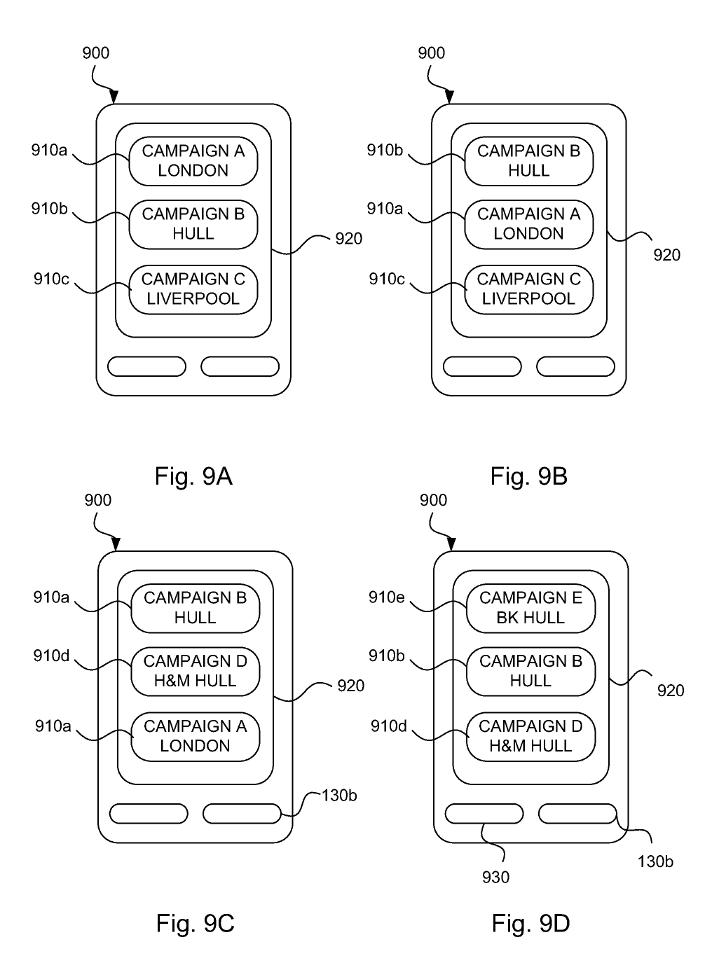

FIG. 9 illustrates a series of display images presented on a user terminal 900 as campaigns 910 has been received. In FIG. 9a three campaigns are currently being shown for a user that is currently in London, England. The three campaigns shown are associated with three different geographic locations, namely London 910a, Hull 910b and Liverpool 910c. As the user travels northwards and the distance thus decreases to Hull and increases to London the user terminal 900 rearranges the campaigns accordingly, see FIG. 9b where the London campaign 910a and the Hull campaign 910b have changed positions on the display 920. As the user terminal 90 enters Hull an updated location is provided to the server 520 and the user terminal 900 is provided with updated campaigns that are relevant to Hull as has been discussed above and the user terminal displays the updated campaigns on the display 920 accordingly, see FIG. 9c, to display a new campaign 910d for the Hull branch of H&M®. The London campaign 910a is now least prioritized and the Liverpool campaign 910c is no longer displayed. The following day a new time period is activated and the user terminal 900 is provided with a new campaign 910e being associated with a restaurant, such as a Burger King® restaurant, from the server 520. The new campaign 910e has a more current time period (that is, the time distance to the time period for the Burger King® campaign is shorter than the time distance to the H&M® campaign) and is thus displayed above the H&M® campaign 910d as can be seen in FIG. 9d.

The teachings herein thus provide a highly versatile manner of ordering and presenting campaigns to a user that ensure that a user is made aware of the campaigns that are of the highest interest at any given time and place. This is further achieved in a manner that is not intrusive to a user's personal integrity and in a manner that is easy to overview without being overwhelmed by an intense advertising information flow.

A user that is interested in a campaign can select the campaign by either touching the campaign's representation 910 on a touch display 920 or by maneuvering a key 930 set of keys. As the campaign is selected the user is presented with information on the campaign, for example through a text, media file (image, video and/or sound), or other content associated with the campaign. A campaign may also be associated with a link and a user terminal 530 is, in one embodiment, configured to activate said link as a campaign is activated. In such embodiments the campaign is associated with a function of presenting the associated content.

A campaign may also be associated with a purchasing function. In one embodiment the user terminal 530 is configured to execute the purchasing function as the campaign is selected. In one embodiment the user terminal 530 is configured to execute the purchasing function after the campaign has been selected, possibly through activation of a further element such as a virtual key marked “buy” or other purchasing manner commonly known.

A campaign 630 may also be associated with a discount rate. A discount rate may in one embodiment be implemented as a discount code that is stored in the user terminal 530. The discount code can be used during a subsequent purchase to provide the specified discount rate. The purchase can be made directly through the campaign, by entering a store, or through a provider's web site to mention a few examples. The discount rate may be associated with more than one campaign, more than one channel, a time period and a geographic area. The discount rate may also be enabled for a single purchase or for a number of purchases.

A campaign 630 may further be associated with an electronic coupon, such as a mobile coupon or internet coupon. An electronic coupon is an electronic ticket solicited and or delivered to an electronic communication device, such as a mobile phone, that can be exchanged for financial discount or rebate when purchasing product or service. A coupon is issued by a provider of consumer packaged goods or retailers, to be used in retail stores as part of a sales promotion. The user terminal 530 is configured to store the electronic coupon and a user is thus able to redeem the coupon at a store or online or through another campaign. In some cases when a user wants to redeem the electronic coupon at store; some retailers forward the redemption to a clearinghouse for final processing.

FIG. 10 is a flow chart illustrating an example of an overall method according to the teachings herein. The method according to FIG. 10 will be described with simultaneous references to FIGS. 5 and 6. A server receives 1010 a registration for a channel 620 and later a subscription 1020 to the channel 620 from a user, possibly through a user terminal 530. The server further receives 1030 a campaign 630 associated with the channel 620. The campaign 630 comprises organisation criteria. The server 520 determines 1040 whether a user is to be a recipient of the campaign 630 based on the organization criteria and if the user has subscribed to the channel 620 that is associated with the campaign 630. If so, the server 520 sends 1050 or distributes the campaign to the user's user terminal 530.

It should be noted that although the teachings herein have been described as relating to a mobile phone 100 as the user terminal the teachings herein are also applicable to a recipient or user having a computer or other device able to receive electronic communications, such as an electronic viewer or tablet, as a user terminal

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single /multi- processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

One benefit of the teachings herein is that an intuitive manner of establishing an overview of a vast multitude of sales offers is achieved, enabling a user or customer to find only the sales offer that is of interest to him and thereby avoid being bewildered and risk missing out on a good offer. The sales offer system is also highly versatile and adaptable to a user's preferences.

The invention has mainly been described above with reference to a few embodiments. However, as is readily appreciated by a person skilled in the art, other embodiments than the ones disclosed above are equally possible within the scope of the invention, as defined by the appended patent claims.

1. A sales offer organizing system comprising a content provider a user terminal, and a server wherein said server is configured to:
receive a registration for at least one channel from said content provider;
receive a subscription to said at least one channel from a user of said user terminal;
receive a campaign associated with said channel from said content provider, said campaign comprising organization criteria;
determine whether said user is to be a recipient for the content based on the organization criteria and whether said user is a subscriber to said channel; and if so,
send the campaign to said user terminal.

2. The sales offer organizing system according to claim 1, wherein said organization criteria comprises an article and/or a prize, a time period and geographic data, and wherein said controller is configured to receive a location for a user terminal and base the determination of the recipient on whether said location corresponds to said geographic data.

3. The sales offer organizing system according to claim 1, wherein said organization criteria further comprises a target group.

4. The sales offer organizing system according to claim 1, wherein said user terminal is configured to receive a first campaign and a second campaign and to present said first campaign and said second campaign in an order based on said organization criteria.

5. The sales offer organizing system according to claim 4, wherein said user terminal is configured to;
determine a location of said user terminal; and
present said first campaign and said second campaign in an order based on a distance from said location to said geographic data said organization criteria.

6. The sales offer organizing system according to claim 4, wherein said user terminal is configured to;
receive an indication of a first number of subscribers to a channel associated with said first campaign;
receive an indication of a second number of subscribers to a channel associated with said second campaign; and
present said first campaign and said second campaign in an order based on the first and second number of subscribers.

7. The sales offer organizing system according to claim 4, wherein said user terminal is configured to;
receive an indication of a first number of users that has been noted to select said first campaign;
receive an indication of a second number of users that has been noted to select said second campaign; and
present said first campaign and said second campaign in an order based on the first and second number of users selecting a campaign.

8. The sales offer organizing system according to claim 4, wherein said user terminal is configured to;
receive an indication of a first number of users that has been noted to make a purchase through said first campaign;
receive an indication of a second number of users that has been noted to make a purchase through said second campaign; and
present said first campaign and said second campaign in an order based on the first and second number of users selecting a campaign.

9. The sales offer organizing system according to claim 4, wherein said user terminal is configured to:
determine a current time of said user terminal;
determine a first time distance for said first campaign based on said current time and said time period of said organization criteria of said first campaign;
determine a second time distance for said first campaign based on said current time and said time period of said organization criteria of said second campaign; and
present said first campaign and said second campaign in an order based on a said first and second time distances.

10. The sales offer organizing system according to claim 4, wherein said user terminal is configured to:
receive an invitation to subscribe to a specified channel;
receive an acceptance of said invitation; and, in response thereto,
send a subscription to said server for said specified channel.

11. The sales offer organizing system according to claim 10, wherein said server is configured to:
receive an invitation for said user to subscribe to a specified channel from a second user terminal;
in response thereto, send said invitation to said user terminal of said user; and
receive a subscription request for said specified channel from said user terminal.

12. The sales offer organizing system according to claim 10, wherein said user terminal is configured to capture an image of a code, interpret said code and according to the code send a request to said server for a channel subscription and/or a campaign as specified by the code.

13. The sales offer organizing system according to claim 1, wherein said server is configured to receive a location for said user terminal and in response thereto provide said user terminal with a listing of campaigns
associated with channels that the user of the user terminal is indicated to be a subscriber of and which have a geographic data that corresponds to the location of the user terminal.

14. A method for use in a sales offer organizing system comprising a content provider, a user terminal and a server, said method comprising:
receiving a registration for at least one channel from said content provider;
receiving a subscription to said at least one channel from a user of said user terminal;
receiving a campaign associated with said channel from said content provider, said campaign comprising organization criteria;
determining whether said user is to be a recipient for the content based on the organization criteria and whether said user is a subscriber to said channel; and if so,
sending the campaign to said user terminal.

15. A computer readable storage medium encoded with instructions that, when executed on a processor, performs the method according to claim 14.

16. A server for use sales offer organizing system comprising a content provider and a user terminal, wherein said server comprises a controller and a memory, wherein said controller is configured to:
receive a registration for at least one channel from said content provider;
receive a subscription to said at least one channel from a user of said user terminal;
receive a campaign associated with said channel from said content provider, said campaign comprising organization criteria;
determine whether said user is to be a recipient for the content based on the organization criteria and whether said user is a subscriber to said channel; and if so,
send the campaign to said user terminal.

17. A user terminal for use in a sales offer organizing system comprising a content provider and a server wherein said user terminal comprises a controller and a memory, wherein said controller is configured to:
send a subscription request for at least one channel;
receive a campaign associated with said channel from said server , said campaign comprising organization criteria;
present said campaign in an order based on said organization criteria;
receive a selection of said campaign, and in response thereto activate a function associated with said campaign.
